(19) United States
(12) Patent Application Publication
(10) Pub. No.: US 2015/0356538 A1
(43) Pub. Date: Dec. 10, 2015

(54) ELECTRONIC RECEIPT MANAGEMENT SYSTEM THAT COORDINATES MANAGEMENT OF ELECTRONIC RECORDS IN A SECURE MANNER

(71) Applicant: TOSHIBA TEC KAUBSHIKI KAISHA, Tokyo (JP)

(72) Inventor: Toru OKADA, Chuo Tokyo (JP)

(21) Appl. No.: 14/733,889

(22) Filed: Jun. 8, 2015

(30) Foreign Application Priority Data
Jun. 10, 2014 (JP) 2014-119933
Jun. 25, 2014 (JP) 2014-130656

(51) Int. Cl. G06Q 20/20; G06Q 20/04; G06Q 20/38

(52) U.S. Cl. CPC G06Q 20/204; G06Q 20/202; G06Q 20/38; G06Q 20/0453

(57) ABSTRACT

A distributed computer system includes a central server, a computing device of a user, and a point-of-sale terminal. The central server is configured to assign a user ID to a user, and store payment information of the user in association with the user ID. The computing device is configured to generate and display a code symbol representing the user ID. The point-of-sale terminal is configured to scan the displayed code symbol and code symbols of merchandise being purchased, and generate first transaction information including the user ID and excluding the payment information and second transaction information about the purchased merchandise. A local server transfers the first and second transaction information from the point-of-sale terminal to the central server. The central server is configured to transmit the payment information to a payment processor to process payment for the merchandise being purchased, and payment confirmation to the local server.

### CROSS-REFERENCE TO RELATED APPLICATION

This application is based upon and claims the benefit of priorities from Japanese Patent Application No. 2014-119933, filed on Jun. 10, 2014, and Japanese Patent Application No. 2014-130656, filed on Jun. 25, 2014; the entire contents of both applications are incorporated herein by reference.

### FIELD

Embodiments described herein relate generally to an electronic receipt management system, in particular, an electronic receipt management system that coordinates management of electronic records in a secure manner.

### BACKGROUND

An electronic receipt system obtains a customer ID of a customer through a media carried by the customer or a symbol code displayed on a display device carried by the customer, and then electrically transmits, to a computing device of the customer, details of a purchase transaction carried out at a retailer, as an electronic receipt. As a purchase activity by the customer can be managed electronically, the customer may manage the purchase activity more efficiently using electronic receipts. Further, as a paper receipt need not be printed, the retailer may be able to reduce printing cost of paper receipts.

Today, many purchase transactions are conducted by variety of non-cash payment methods, such as a credit card, an electronic money card, and the like. As customers and retailers do not need to handle cash, the purchase transactions can be conducted more quickly and efficiently. In addition, the number of customers who uses such non-cash payment methods is increasing.

If a customer wants to pay by a non-cash method and receive an electronic receipt in a transaction, the customer may need to present both a media that indicates the customer ID and a media of the non-payment method. Further, since the customer needs to present the media of the non-payment method, there is a risk that payment information printed on the media may be exposed to others, or a risk that the payment information is stolen during data transfer thereof.

### BRIEF DESCRIPTION OF THE DRAWINGS

FIG. 1 is a block diagram illustrating an electronic receipt system according to a first embodiment.

FIG. 2 is a block diagram of a POS terminal in the electronic receipt system.

FIG. 3 is a block diagram of an electronic receipt server in the electronic receipt system.

FIG. 4 is a block diagram of an electronic receipt management server in the electronic receipt system.

FIG. 5 is a block diagram of a portable terminal in the electronic receipt system.

FIG. 6 illustrates functional blocks of the POS terminal relating to electronic receipt processing.

FIG. 7 illustrates an example of an image of a receipt data.

FIG. 8 illustrates an example of an electronic receipt.

FIG. 9 is a flowchart illustrating the electronic receipt processing carried out by the POS terminal.

FIG. 10 is a flowchart illustrating electronic receipt management processing and information transmission processing carried out by the electronic receipt server.

FIG. 11 illustrates functional blocks of the electronic receipt management server relating to the electronic receipt management processing and commodity information transmission processing.

FIG. 12 is a flowchart illustrating the electronic receipt management processing and the commodity information transmission processing carried out by the electronic receipt management server.

FIG. 13 illustrates functional blocks of the portable terminal relating to electronic receipt reception processing and electronic receipt displaying processing.

FIG. 14 is a flowchart illustrating the electronic receipt reception processing and the electronic receipt displaying processing carried out by the portable terminal.

FIG. 15 illustrates an example of an electronic receipt displayed on a display unit of the portable terminal.

FIG. 16 illustrates another example of the electronic receipt displayed on the display unit of the portable terminal.

FIG. 17 illustrates a whole electronic receipt system according to a second embodiment.

FIG. 18 illustrates functional blocks of a POS terminal relating to electronic receipt processing.

FIG. 19 is a flowchart illustrating the electronic receipt processing carried out by the POS terminal.

FIG. 20 illustrates functional blocks of an electronic receipt management server relating to electronic receipt management processing and commodity information transmission processing.

FIG. 21 is a flowchart illustrating the electronic receipt management processing and the commodity information transmission processing carried out by the electronic receipt management server.

### DETAILED DESCRIPTION

In accordance with an embodiment, a distributed computer system is configured to coordinate management of electronic records in a secure manner, and includes a central server, a computing device of a user, and a point-of-sale terminal. The central server is configured to assign a user ID to a user when the user registers therewith, and store payment information of the user in association with the user ID. The computing device is configured to generate a code symbol representing the user ID, and display the code symbol on a display unit thereof. The point-of-sale terminal is configured to scan the code symbol displayed on the computing device and code symbols of merchandise being purchased, and generate first transaction information including the user ID represented by the code symbol and excluding the payment information and second transaction information including information about the purchased merchandise. A local server receives the first and second transaction information from the point-of-sale terminal and transmits the first transaction information to the central server and then the second transaction information to the central server upon receiving payment confirmation from the central server. In response to receiving the first transaction information from the local server, the central server is configured to retrieve the payment information of the user that is stored in association with the user ID, and transmit the payment information to a payment processor to process payment for the merchandise being purchased. In response to receiving conformation that the payment has been approved, the central server transmits the payment confirmation to the local server.

### First Embodiment

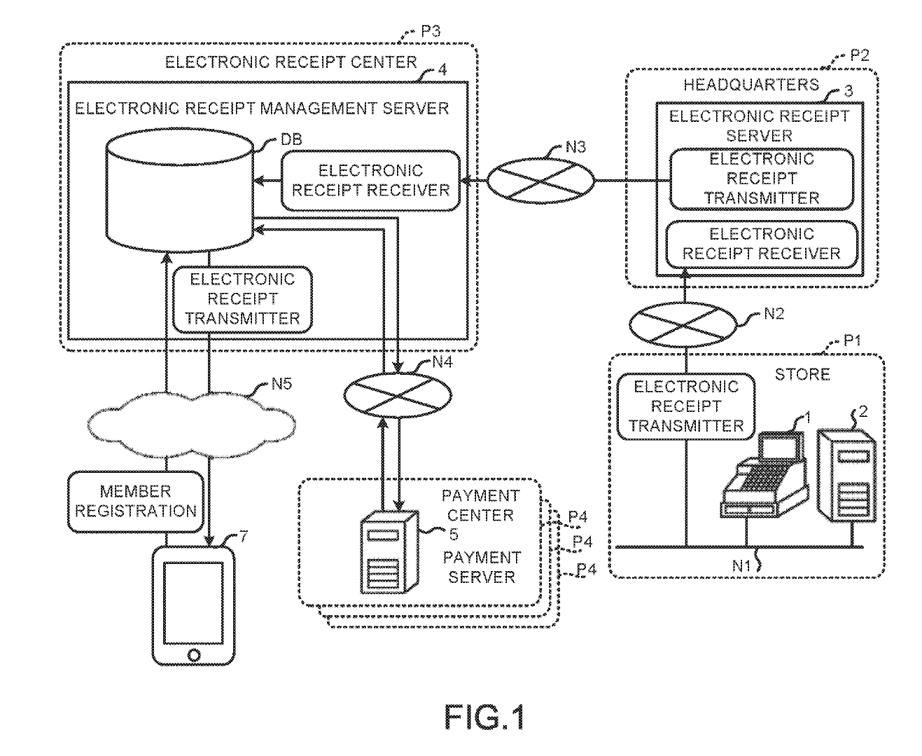

FIG. 1 is a block diagram of an electronic receipt system according to a first embodiment. As shown in FIG. 1, the electronic receipt system includes a POS (Point of Sales) terminal 1, a store server 2, an electronic receipt server 3, an electronic receipt management server 4, and a portable terminal 7.

The POS terminal 1 and the store server 2 are located in a store P1. The POS terminal 1 and the store server 2 are connected to be capable of communicating with each other through an in-store network N1 such as an LAN (Local Area Network). Further, the POS terminal 1 and the store server 2 are connected, through a network machine (not shown) such as a router connected to the in-store network N1, to a network N2 which connects the store P1 and a headquarters P2. The network N2 is, for example, a dedicated line such as the internet, a VPN (Virtual Private Network) and the like.

The POS terminal 1 is a commodity sales data processing device and executes commodity sales data processing (commodity transaction data processing). The POS terminal 1 generates a receipt data including content of a purchase transaction, and a printer 13 prints out a paper receipt based on the receipt data. The POS terminal 1 further outputs (transmits) an electronic receipt, which is obtained by converting the data format of the receipt data, to the electronic receipt server 3 via the network N2. There is no limitation as to the transmission method of the electronic receipt, and the electronic receipt may be transmitted using a general protocol such as the HTTP, the HTTPS and the like. Further, the number of the POS terminal 1 provided in the store P1 is not limited, and may be more than one.

The store server 2 conducts management of commodity sales data processing carried out by the POS terminal 1. For example, the store server 2 stores and manages the commodity sales data generated through the commodity sales data processing by the POS terminal 1, and commodity data files used during the commodity sales data processing.

In the present embodiment, the POS terminal 1 outputs the electronic receipt. However, the present invention is not limited to this configuration. The data format of the receipt data generated by the POS terminal 1 may be converted by the store server 2 or a conversion device (not shown), and the converted data may be output as an electronic receipt to the electronic receipt server 3.

The electronic receipt server 3, which is located in the headquarters P2 of a company that operates one or more stores or chain stores, functions as a receipt management server for company and manages the receipt data of a company. The electronic receipt server 3 has a function to perform operations, such as sales management, sales analysis, stock management, and the like of the company.

Further, the electronic receipt server 3 receives the electronic receipt transmitted from the POS terminal 1 through the network N2. The electronic receipt server 3 then transmits the received electronic receipt to the electronic receipt management server 4 through a network N3 which connects the headquarters P2 and an electronic receipt center P3.

The network N3 is, for example, a dedicated line such as the internet, a VPN, and the like. Here, the transmission method of the electronic receipt is not limited, and general protocol such as the HTTP, the HTTPS, and the like may be employed.

The electronic receipt management server 4 is located in the electronic receipt center P3. The electronic receipt center P3 is, for example, a third party organization other than the companies that manage the receipt data using the electronic receipt servers 3. Alternatively, the electronic receipt server 3 may also be managed by the third party organization and the like.

The electronic receipt management server 4 functions as a receipt management server for customer and collectively managing receipt data of multiple companies, each of which operates one or more stores. The electronic receipt management server 4 stores and manages, according to a procedure, member data such as name, a member code, transmission destination information (for example, mail address) of the portable terminal 7 as the transmission destination of the electronic receipt of the customer (member) subjected to member registration processing in a member master stored in a database DB. Further, a member management server and the like may be provided to carry out storage/management of the member data, separately from the electronic receipt management server 4.

The electronic receipt management server 4 receives the electronic receipt from the electronic receipt server 3 through the network N3, and stores and manages the received electronic receipt in an electronic receipt management region 43a (see FIG. 4) in the database DB. The electronic receipt includes information such as a member code, in addition to the content of a purchase transaction (commodity sales data), and is managed in association with the member data of the corresponding member.

After the electronic receipt is stored in the database DB, the electronic receipt management server 4 refers to the transmission destination information associated with the member code of the electronic receipt to specify the transmission destination (the portable terminal 7). Then, the electronic receipt management server 4 transmits the electronic receipt stored in the database DB to the specified transmission destination through a network N5.

If an electronic receipt inquiry designating a member code is received from the portable terminal 7, which is connected through the network N5, the electronic receipt management server 4 extracts the electronic receipt corresponding to the member code from the database DB and transmits the extracted electronic receipt to the portable terminal 7.

The electronic receipt management server 4 is connected through a network N4 to a payment server 5 that is located in a payment center P4 of a financial institution, such as a credit company, a bank, an electronic money company, or the like. The network N4 is, for example, a dedicated line such as the CAFIS (Credit and Finance Information Switching System), a VPN and the like, and usually a more secure network than other networks including the network N3. Further, in the present embodiment, the number of the payment server 5 provided in the payment center P4 is set to one or more. The electronic receipt management server 4 selects one payment server 5 at the time of payment processing according to a method.

The portable terminal 7, which is used by the user (customer) of the electronic receipt system, is a terminal device such as a smart phone, a mobile phone, a PDA (Personal Digital Assistant), a tablet computer, or the like. Applications such as a Web browser for browsing various kinds of information provided on the network N5 are installed in the portable terminal 7. A terminal device such as a PC may also be used instead of the portable terminal 7.

The portable terminal 7 accesses the electronic receipt management server 4 via the network N5 to carry out member registration to the electronic receipt system. The network N5 is the internet or various public lines.

The member registration of customer in the present embodiment may be carried out according to the following procedure. The customer transmits a blank email from the portable terminal 7 to the electronic receipt management server 4 via the network N5. The electronic receipt management server 4 transmits a URL (Uniform Resource Locator) of a webpage for member registration to the received mail address. The customer accesses the webpage for member registration through the portable terminal 7 using the received URL, and the portable terminal 7 displays an input screen for inputting information (name, transmission destination information, and the like) required for the member registration. After the required information is input, the electronic receipt management server 4 executes the member registration in the member master. Then, the electronic receipt management server 4 distributes a member registration completion mail including a member code (customer code) and a password to the portable terminal 7. As a result, the member registration is completed.

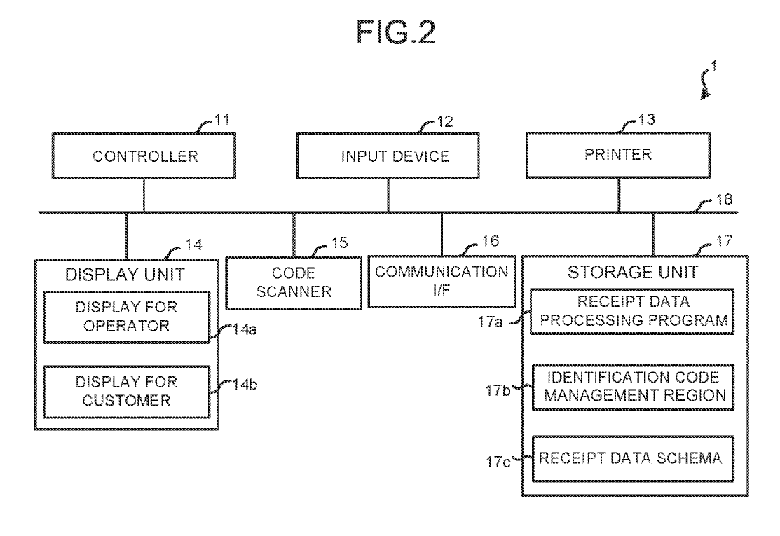

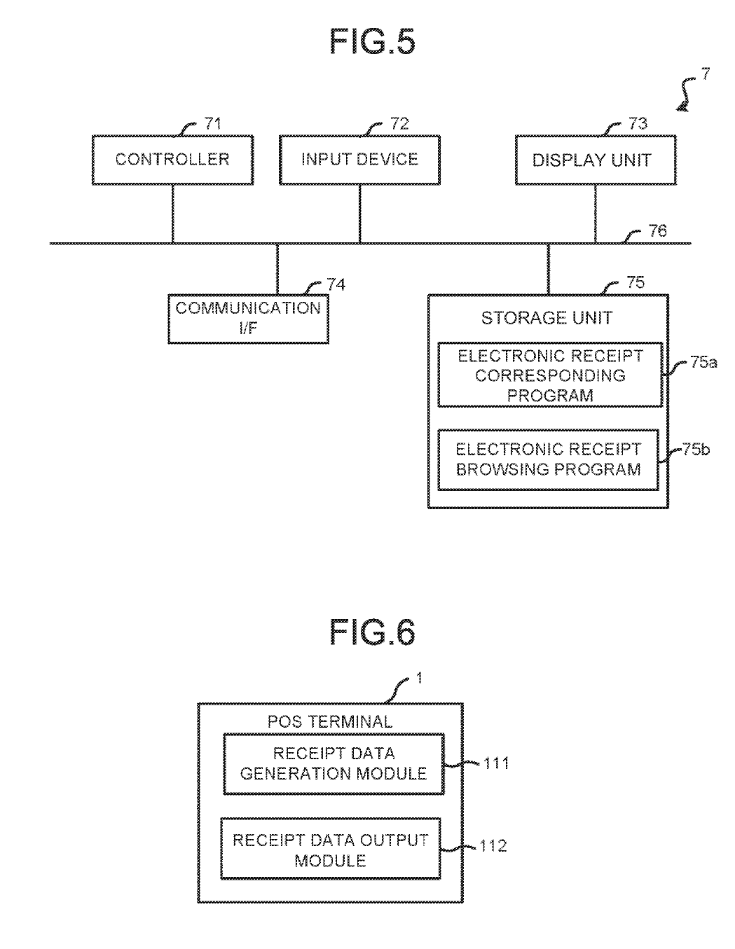

After the member registration described above is carried out, the portable terminal 7 displays the member code of the customer on a display unit 73 (refer to FIG. 5) as a code symbol such as a barcode, a two-dimensional code, or the like. The customer presents the code symbol displayed on the portable terminal 7 to a shop clerk during the purchase transaction in the store P1. The shop clerk scans the code symbol displayed on the portable terminal 7 using a code scanner 15 (refer to FIG. 2) connected to the POS terminal 1. As a result, the member code of the customer is associated with the receipt data generated after the commodity sales data processing by the POS terminal 1.

After the payment (transaction) with the POS terminal 1, the portable terminal 7 receives the electronic receipt of the purchase transaction from the electronic receipt management server 4 via the network N5. The customer may receive the electronic receipt on the portable terminal 7 in response to transmitting an electronic receipt inquiry designating the member code of the customer to the electronic receipt management server 4 via the network N5. The portable terminal 7 displays the received electronic receipt on the display unit 73.

In the electronic receipt system of the configuration described above, the electronic receipt (receipt data) indicating the content of the purchase transaction (payment) generated through commodity sales data processing by the POS terminal 1 in the store P1 is transmitted to the electronic receipt management server 4 via the electronic receipt server 3 and uploaded on the Web. Thus, the portable terminal 7 which has the Web browser can download the receipt data uploaded on the Web to the portable terminal 7 by designating the URL (Uniform Resource Locator) and display an electronic image of the receipt data on the display unit 73. Further, a different application may be installed in the portable terminal 7 to browse the receipt data.

Next, the main devices included in the electronic receipt system of the present embodiment are described in detail.

First, the POS terminal 1, which serves as the commodity sales data processing apparatus, is described. FIG. 2 is a block diagram of the POS terminal 1. As shown in FIG. 2, the POS terminal 1 comprises a controller 11 which collectively controls various operations and each unit of the POS terminal 1. The controller 11 includes a CPU (Central Processing Unit), an ROM (Read Only Memory) for storing various programs and data, an RAM (Random Access Memory) that temporarily stores various programs and stores various data in a rewritable manner, an RTC (Real Time Clock) unit that indicates the current date and time and the like.

The controller 11 is connected to an input device 12, the printer 13, a display unit 14, and the code scanner 15, via a bus line 18.

The input device 12 includes various operation keys for an operator to carry out input operations. The operation keys include, for example, numeric keys for inputting numerals, a cursor key, a selection determination key for selecting an item, a subtotal key for instructing output of a total price of commodities subjected to sales registration processing during a purchase the transaction, a closing key for closing processing of the purchase transaction, and the like.

The printer 13 is a printer device for carrying out printing of a receipt, a journal, and the like. The printer 13 includes a cut mechanism (not shown) for cutting paper such as a roll paper to be printed, and cuts paper according to a cut command.

The display unit 14 which is, for example, a liquid crystal display and displays various kinds of information such as the commodity name, unit price, total price of one purchase transaction, change amount, and the like of commodities subjected to the sales registration processing. The display unit 14 includes a display 14a for operator for displaying various kinds of information to a cashier and a display 14b for customer for displaying various kinds of information to the customer. Further, the display unit 14 may be a touch panel, and in this case, the touch panel functions as the input device 12.

The code scanner 15 is a scanner device which optically reads code symbols such as a barcode, a two-dimension code, and the like. For example, the code scanner 15 reads a code symbol printed on a commodity, or a code symbol displayed on the portable terminal 7, and outputs information contained in the code symbol to the controller 11. Further, it is assumed that the commodity code for specifying the commodity is contained in the code symbol printed on the commodity. It is also assumed that the member code (customer code) for specifying the customer who carries the portable terminal 7 is contained in the code symbol displayed on the portable terminal 7.

The controller 11 is connected to a communication I/F (interface) 16 via the bus line 18, and to the in-store network N1 and the network N2 via the communication I/F 16.

The controller 11 is also connected to a storage unit 17 via the bus line 18. The storage unit 17 is an auxiliary storage device such as an HDD (Hard Disk Drive), an SSD (Solid State Drive) and the like. The storage unit 17 stores programs for executing various kinds of POS operations including the commodity sales data processing. Further, the storage unit 17 stores various kinds of data files relating to the commodity sales data processing such as a commodity data file in which the commodity data including commodity name, a commodity code, price, and the like of each commodity is stored. The storage unit 17 further stores a receipt data processing program 17a for carrying out the commodity sales data processing and processing relating to the receipt data.

Further, the storage unit 17 stores a POS number for identifying the self-POS terminal 1, a company code (identification code of a company operating stores: transaction destination code), a code of business type and business style, a store code indicating the store P1 where the POS terminal 1 is located, and the like, in an identification code management region 17b. The code of business type and business style is a code (classification code) classifying the business type and business style of a store, such as a convenience store, a supermarket, a department store, a pharmacy, a restaurant, an eatery, and the like. In addition, such a business type and business style can be changed according to the preference of the user. The company code (identification code of a company operating the store) and the code of business type and business style may be registered in the electronic receipt server 3.

The storage unit 17 also stores a receipt data schema 17c in which a conversion rule used when the unstructured receipt data is converted into the structured-format data (hereinafter, electronic receipt) is defined.

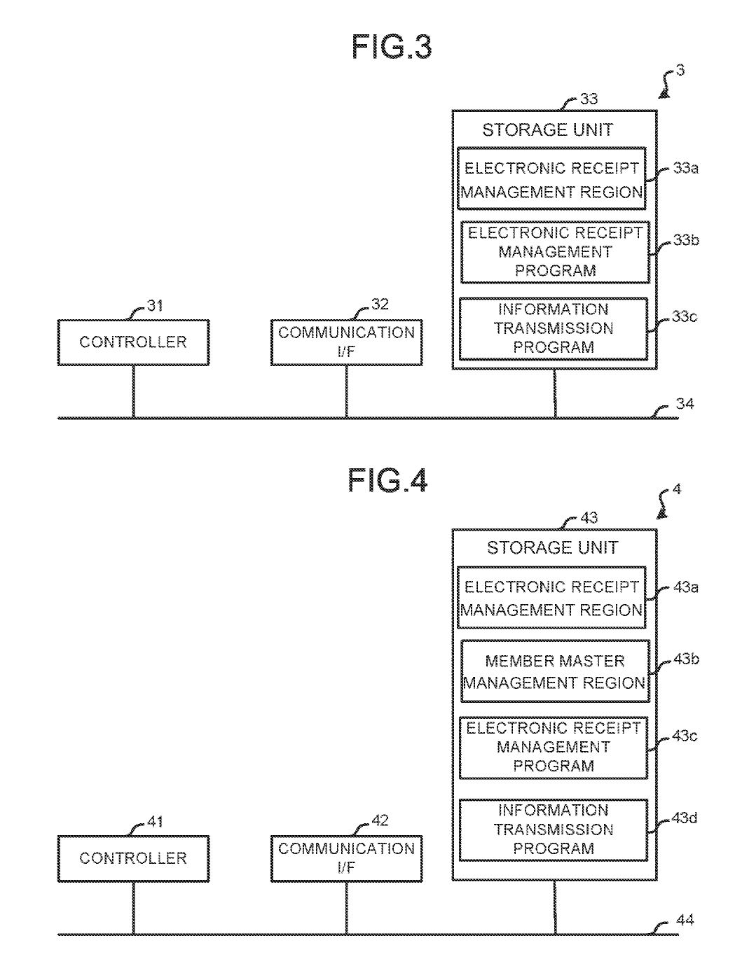

Next, the configuration of the electronic receipt server 3, which functions as the receipt management server for company, is described with reference to the block diagram of FIG. 3. The electronic receipt server 3 includes a controller 31 which collectively controls various operations and each unit of the electronic receipt server 3. The controller 31 includes a CPU, an ROM for storing various programs and data, an RAM that temporarily stores various programs and stores various data in a rewritable manner, an RTC unit that indicates the current date and time and the like.

The controller 31 is connected to the network N2 and the network N3 via a communication I/F 32, which is connected to a bus line 34, and is also connected to a storage unit 33 via the bus line 34.

The storage unit 33 stores electronic receipts of a company that operates one or more stores in an electronic receipt management region 33a. Each of the electronic receipts contains a company code (an identification code of the company), a code of business type and business style, a store code, a member code of a customer, a POS number of a POS terminal 1, a receipt number, commodity sales data, and the like.

The storage unit 33 also stores an electronic receipt management program 33b for managing the electronic receipts stored in the electronic receipt management region 33a. The storage unit 33 further stores an information transmission program 33c for transmitting the receipt data stored in the electronic receipt management region 33a to the electronic receipt management server 4.

Next, the configuration of the electronic receipt management server 4, which functions as the receipt management server for customer, is described with reference to the block diagram of FIG. 4. As shown in FIG. 4, the electronic receipt management server 4 comprises a controller 41 which collectively controls various operations and each unit of the electronic receipt management server 4. The controller 41 includes a CPU, an ROM for storing various programs and data, an RAM that temporarily stores various programs and stores various data in a rewritable manner, an RTC unit that indicates the current date and time and the like.

The controller 41 is connected to the network N3 and the network N5 via a communication I/F 42, which is connected to a bus line 44. The controller 41 is also connected to a payment server 5 that is located in a financial institution, such as a credit company or a bank, through a network N4 (such as the CAFIS) via the communication I/F 42 connected to the bus line 44, and carries out data communication with the payment server 5. The controller 41 is connected to the storage unit 43 via the bus line 44.

The storage unit 43 includes an electronic receipt management region 43a for collectively storing the electronic receipts of multiple companies operating the stores. More specifically, the electronic receipt management region 43a is used to manage the electronic receipts of the multiple companies, with respect to each member (customer).

Each of the electronic receipts contains a member code, a company code (identification code of the company operating the store), a store code, a POS number of a POS terminal 1, a receipt number, commodity sales data (including date and time data), and the like. Referring to the electronic receipts, consumer goods manufacturers and the like may be able to acquire proof of purchased commodities manufactured thereby, in accordance with a specific condition (for example, specific company operating a store, a specific region, a specific time of purchase, and the like). Further, the consumer goods manufacturers may be manufacturers of, for example, grocery, beverages, clothing, cosmetics, medicine, daily necessities, and the like.

Further, the storage unit 43 includes a member master management region 43b for storing and managing a member master. The member master stored in the member master management region 43b stores name, address and the like of the member in association with the member code.

In addition, the member master stored in the member master management region 43b contains information of at least one payment medium to be used in a payment according to commodity sales data processing by the POS terminal 1, in association with a member code. The payment medium may refer to the credit card, the electronic money card, the debit card, and the like. Further, a priority order of the payment media set in advance by the consumer corresponding to the member code is associated with the payment media.

Specifically, the member master stored in the member master management region 43b contains one or more medium categories and identification codes, for each payment medium. When the payment medium is a credit card, the medium category may refer to one of credit companies, such as a credit company A, a credit company B, a credit company C . . . . Further, a priority order of the payment media set by the consumer is associated with each medium category.

In addition to the member management program (not shown) for managing the member master stored in the member master management region 43b, the storage unit 43 further stores an electronic receipt management program 43c for managing the electronic receipts of each company stored in the electronic receipt management region 43a. The storage unit 43 further stores an information transmission program 43d for transmitting the electronic receipt to the portable terminal 7. In addition, the electronic receipt management region 43a and the member master management region 43b correspond to the database DB shown in FIG. 1.

Next, the configuration of the portable terminal 7 is described with reference to the block diagram of FIG. 5. As shown in FIG. 5, the portable terminal 7 includes a controller 71 which collectively controls various operations and each unit of the portable terminal 7. The controller 71 includes a CPU, an ROM for storing various programs and data, an RAM that temporarily stores various programs and stores various data in a rewritable manner, an RTC unit that indicates the current date and time and the like.

The controller 71 is connected to an input device 72 and a display unit 73, via a bus line 76. The input device 72 includes various operation keys for a user (customer) to carryout input operation inputs and a pointing device. The display unit 73 is, for example, a liquid crystal display and the like, and displays various kinds of information including an electronic receipt. Further, the display unit 73 may be a touch panel, and in this case, the touch panel also functions as the input device 72.

The controller 71 is connected to a communication I/F 74 via a bus line 76, and is to the network N5 via the communication I/F 74. The controller 71 is configured to be connected to the in-store network N1 via the communication I/F 74.

The controller 71 is also connected to a storage unit 75 via the bus line 76. In addition to the Web browser for browsing various kinds of information (contents) uploaded on the Web, the storage unit 75 stores an electronic receipt correspondence program 75a for receiving the electronic receipt from the electronic receipt management server 4 and an electronic receipt browsing program 75b for displaying the received receipt data.

Next, the operations of each unit of the electronic receipt system according to the present embodiment are described.

First, the electronic receipt processing performed when the controller 11 of the POS terminal 1 executes the receipt data processing program 17a is described with reference to the FIGS. 6-9.

As shown in FIG. 6, when the receipt data processing program 17a is executed by the POS terminal 1, modules including a receipt data generation module 111 and a receipt data output module 112 are generated. As practical hardware, by reading the receipt data processing program 17a from the storage unit 17 and then executing it using the CPU of the controller 11, the receipt data generation module 111 and the receipt data output module 112 are loaded in the RAM.

The receipt data generation module 111 is a functional unit which mainly carries out the commodity sales data processing, generates printing data of a receipt (receipt data), and corresponds to an existing application. The receipt data generation module 111 reads, if the commodity code specifying a commodity is acquired through the code scanner 15, the commodity data corresponding to the commodity code from the commodity data file and calculates the price of the commodity based on a unit price contained in the commodity data. Then, the receipt data generation module 111 generates the commodity sales data through the commodity sales data processing, that is, the receipt data including the content of the purchase transaction.

If the member code (reception destination code) specifying the customer (reception destination) is acquired through the code scanner 15 at any timing during one purchase transaction, the receipt data generation module 111 includes the member code in the receipt data. Here, the reception destination code is not limited to the member code, and may be an identification code capable of identifying the reception destination.

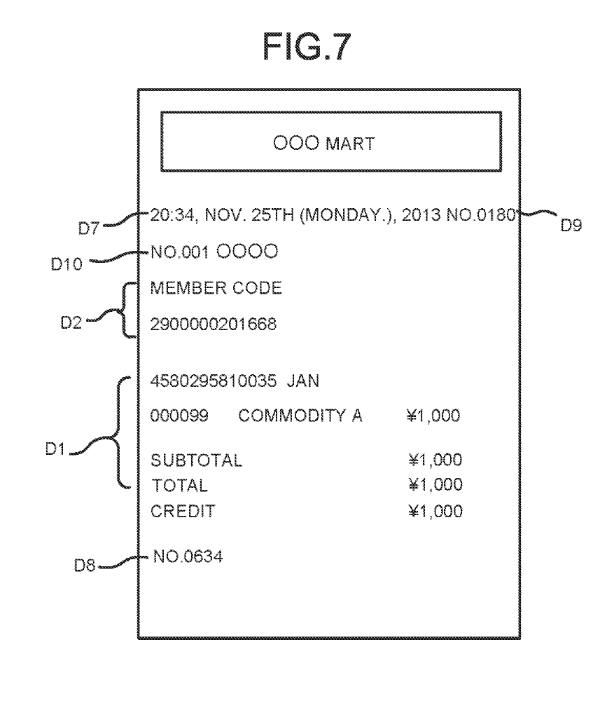

FIG. 7 illustrates an example of an image of the receipt data. Here, the receipt data, which is unstructured text data and the like, is used for the printing by the printer 13. As shown in FIG. 7, the image of the receipt data includes commodity sales data D1 and a member code D2. The commodity sales data D1 contains the commodity name (commodity code) and quantity of the purchased commodity, the total price of the purchased commodity, the deposit amount paid by the customer, the change amount, and the like.

The receipt data further includes transaction date and time D7, a transaction number (receipt number) D8, a register number D9, a name of person in charge D10, and the like. The elements of the receipt data are not limited to the example in FIG. 7, and may contain other elements such as a company code (company name) indicating the company operating the store, a store code (store name), a telephone number of the store, an address, a code of the business type and business style, and the like.

If operation of the closing key is detected, the receipt data generation module 111 determines that the commodity sales data processing of one purchase transaction has been completed, and outputs (issues) the generated receipt data and a cut command to the receipt data output module 112. Here, the cut command is one of printer control commands used generally, and instructs the cut (cutting) of paper on which the receipt data is printed. Here, the receipt data may be generated collectively after the pressing of the closing key, or may be accumulated sequentially every time a commodity code or a customer code is acquired.

Every time the receipt data of one purchase transaction is generated by the receipt data generation module 111, the receipt data output module 112 determines an output destination of the generated receipt data. More specifically, if the cut command is issued by the receipt data generation module 111, the receipt data output module 112 determines that the receipt data of the one purchase transaction has been generated. Then, the receipt data output module 112 determines whether or not the generated receipt data contains the member code, and outputs the receipt data to an output destination according to the determination result.

Specifically, if it is determined that the receipt data does not contain the member code, the receipt data output module 112 outputs the receipt data to the printer 13 together with the cut command. Then, the printer 13 prints the receipt data on paper, and outputs a paper receipt of the purchase transaction after cutting the paper according to the cut command. Here, during the printout, all elements of the receipt data may be printed, or the receipt data may be printed after removing the member code and the like or adding other information such as an advertisement.

If it is determined that the receipt data contains the member code, the receipt data output module 112 converts the receipt data into a data format according to the conversion rule defined in the receipt data schema 17c. Then, the receipt data output module 112 transmits (outputs) the receipt data of which the data format has been converted, that is, the electronic receipt, to the electronic receipt server 3 of the corresponding company.

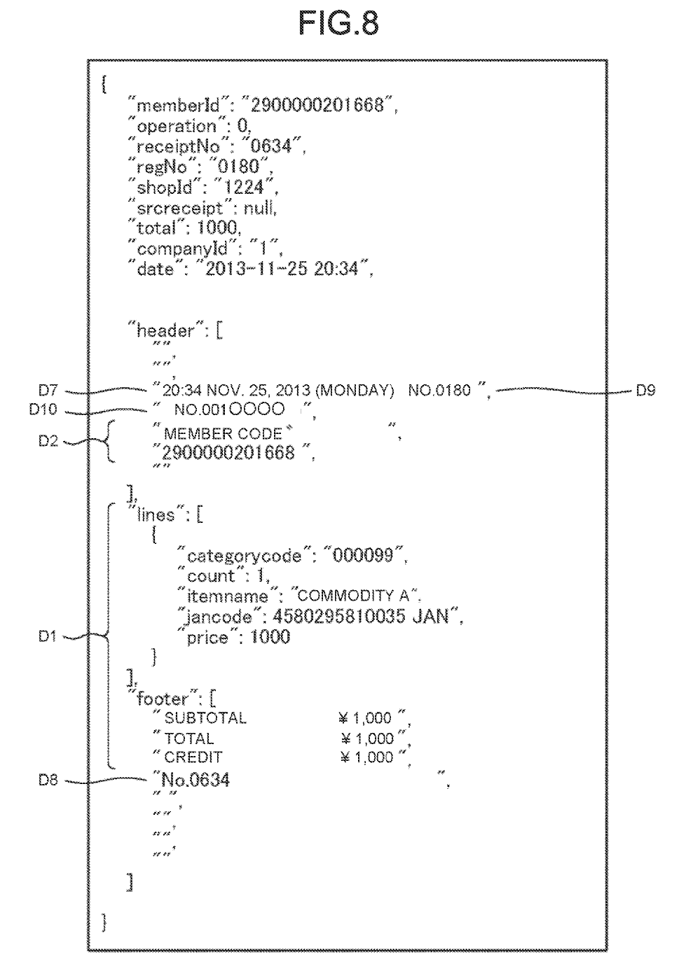

FIG. 8 illustrates an example of data of the electronic receipt. As shown in FIG. 8, the electronic receipt includes structured format data (structured document) such as XML, CSV, JSON (JavaScript (registered trademark) Object Notation) and the like. Further, in FIG. 8, each element (D1˜D2, D7˜D10) of the receipt data shown in FIG. 7 is converted into the JSON format.

The conversion from the receipt data into the electronic receipt is carried out according to the conversion rule defined in the receipt data schema 17c. Specifically, in the receipt data schema 17c, predetermined elements of the receipt data and attribute information (such as a tag) indicating the attribute of each element are defined. By using and structuring the attribute information corresponding to each element of the receipt data, the receipt data output module 112 generates electronic receipt of the structured format as shown in FIG. 8. By converting the receipt data into the electronic receipt of the structured format, the elements of the electronic receipt can be efficiently utilized, and it is possible to obtain various advantages in data management.

As described above, the receipt data output module 112 determines, according to the issuing of the cut command by the receipt data generation module 111, that the receipt data of one purchase transaction has been generated and starts outputting the receipt data. Here, a dedicated signal from the receipt data generation module 111 is not required to notify the receipt data output module 112 that one purchase transaction has been completed. As a result, the output of the receipt data of one purchase transaction can be carried out by the receipt data output module 112 without changing the configuration of the receipt data generation module 111, which corresponds to the existing application. In addition, since the receipt data generation module 111 does not need to be changed, it is possible to achieve the output function of the electronic receipt while efficiently using the existing application.

Further, the receipt data output module 112 determines, according to whether or not a receipt data contains the member code, an output destination of the receipt data. As the output of paper receipt or the output of electronic receipt can be carried out without information indicating whether or not each customer requests a paper receipt, it is possible to determine the output destination of the receipt data more efficiently. Further, as the customer (member) can select the output of a paper receipt or an electronic receipt based on input/non-input of the member code in each purchase transaction, the customer can use the electronic receipt system more conveniently.

Further, when the receipt data is output to the electronic receipt server 3, the receipt data output module 112 converts the elements of the receipt data into the structured format and outputs the receipt data as the electronic receipt. As a result, the elements of the electronic receipt can be used more efficiently by the electronic receipt server 3 and the electronic receipt management server 4 for managing the electronic receipt and by the portable terminal 7 for carrying out display of the electronic receipt.

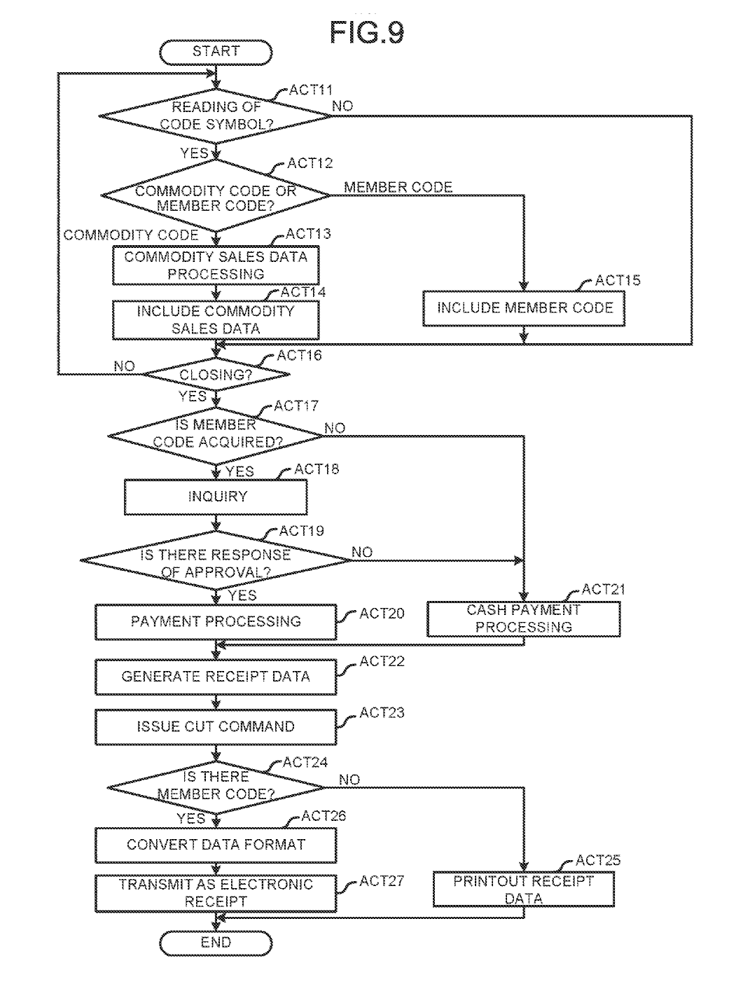

FIG. 9 is a flowchart illustrating electronic receipt processing carried out by the POS terminal 1. First, the receipt data generation module 111 of the POS terminal 1 determines whether or not the code symbol (commodity code) printed on the commodity or the code symbol (member code) displayed on the portable terminal 7 is read through the code scanner 15 (ACT 11). When the code symbol is not read (NO in ACT 11), the process proceeds to ACT 16.

To the contrary, if it is determined that the code symbol is read (YES in ACT 11), the receipt data generation module 111 determines whether the read code symbol is a commodity code or a member code (ACT 12).

In ACT 12, when the read code symbol is the commodity code (ACT 12: commodity code), the receipt data generation module 111 reads the commodity data of the commodity specified by the commodity code from the commodity data file, and calculates a price based on the unit price contained in the commodity data (ACT 13). Next, the receipt data generation module 111 generates the receipt data including the commodity sales data processed during the commodity sales data processing (ACT 14).

Further, when the read code symbol is the member code in ACT 12 (ACT 12: member code), the receipt data generation module 111 includes the member code in the receipt data (ACT 15).

In order to input the member code to the POS terminal 1, for example, the customer (member) presents the code symbol of the member code and the like displayed on the display unit 73 of the portable terminal 7, and the shop clerk or the customer (member) scans the code symbol using the code scanner 15 of the POS terminal 1. Further, the receipt data generation module 111 may perform an exclusive processing such that only one member code is associated with the purchase transaction when more than two member codes are acquired.

Sequentially, in ACT 16, the receipt data generation module 111 determines whether or not the closing processing is instructed according to the press of the closing key (ACT 16). When the closing processing is not instructed (NO in ACT 16), the process returns to ACT 11. When the closing processing is instructed (YES in ACT 16) and a member code is acquired in ACT 12 (YES in ACT 17), the member code acquired in ACT 12 is transmitted to the electronic receipt management server 4 to inquire an identification code and a designated (prioritized) payment medium (for example, a credit card, an electronic money card, a debit card, and the like) that is associated with the member code (ACT 18).

When there is a response of a payment approval according to the designated (prioritized) payment medium (e.g., a credit card, an electronic money card, a debit card, and the like) that is associated with the member code from the electronic receipt management server 4 and the identification code (YES in ACT 19), the receipt data generation module 111 executes closing processing (payment processing) with the approved payment medium (ACT 20).

On the other hand, when there is no response of a payment approval according to the payment medium (e.g., a credit card, an electronic money card, a debit card and the like) (NO in ACT 19), the receipt data generation module 111 executes the closing processing (payment processing) with cash (ACT 21). Also when a member code is not acquired in ACT 12 (NO in ACT 17), the receipt data generation module 111 executes the closing processing (payment processing) with cash (ACT 21).

After the closing processing (payment processing) is carried out, the receipt data generation module 111 generates the receipt data of one purchase transaction (ACT 22). Further, when the closing processing (payment processing) using the approved payment medium is executed, the receipt data generation module 111 generates payment slip data (customer-oriented) of a format set for the approved payment medium as a proof of the payment processing using the payment medium.

Next, the receipt data generation module 111 issues (outputs) the cut command to the receipt data output module 112 (ACT 23).

If the cut command is received from the receipt data generation module 111, the receipt data output module 112 determines that the receipt data of one purchase transaction has been generated and determines whether or not the receipt data contains the member code (ACT 24).

When the receipt data does not contain the member code (NO in ACT S24), the receipt data output module 112 outputs the receipt data of the purchase transaction to the printer 13 together with the cut command to print out the receipt data (ACT 25), and terminates the processing. Then, the printer 13 prints the receipt data on the paper and outputs a paper receipt of the purchase transaction after cutting the paper according to the cut command.

Further, when closing processing (payment processing) by the approved payment medium is executed, the payment slip data (customer-oriented) of the format set for each payment medium is also printed out as the proof of the payment processing by the payment medium.

On the other hand, when the receipt data contains the member code (YES in ACT 24), the receipt data output module 112 converts the data format of the receipt data (unstructured format) into structured format to generate electronic receipt (ACT 26).

Further, when the closing processing (payment processing) by the approved payment medium is executed, the data format of the payment slip data (customer-oriented) is also converted into the structured format. In this manner, an electronic receipt is generated.

Then, the receipt data output module 112 transmits the generated electronic receipt to the electronic receipt server 3 via the communication I/F 16 (ACT 27), and terminates the processing.

In the processing described above, when the receipt data contains the member code, the receipt data is output to the electronic receipt server 3. However, the present invention is not limited to this processing. For example, the receipt data may be output to both the printer 13 and the electronic receipt server 3.

Further, when the receipt data contains the member code, the output destination of the receipt data may be set to be selectable. For example, the portable terminal 7 includes output classification information designating the output destination of the receipt data in the code symbol to be displayed so as to select the output destination based on the output classification information. In this case, the receipt data generation module 111 includes the output classification information read by the code scanner 15 in the receipt data together with the member code. Then, if it is determined that the receipt data contains the member code and the output classification information, the receipt data output module 112 determines the output destination of the receipt data based on the output classification information. In addition, in the output classification information, it is possible to designate either one or both of the printer 13 and the electronic receipt server 3.

Alternatively, the output destination of the receipt data may be selected every time a purchase transaction is conducted. In such a case, for example, if it is determined that the receipt data contains the member code, the receipt data output module 112 may display an output destination selection screen for selecting the output destination of the receipt data on the display unit 14.

Further, the selection screen may be displayed either one or both of the display 14a for operator and the display 14b for customer. In addition, when the display 14b for customer has a touch panel, the customer may select the output destination by herself/himself using the touch panel.

Further, the output destination of the receipt data may be selected by the customer during the commodity sales data processing. In this case, the receipt data generation module 111 displays an output destination selection screen and the like on the display unit 14, and the output destination corresponding to a selection operation is contained in the receipt data as the output classification information. Then, if the receipt data contains the member code and the output classification information, the receipt data output module 112 determines the output destination of the receipt data based on the output classification information.

As described above, when the receipt data contains the member code, the receipt data output module 112 may receive the automatic selection of the output destination of the receipt data or the manual selection of the output destination. As a result, the determining method of the output destination can be flexibly set.

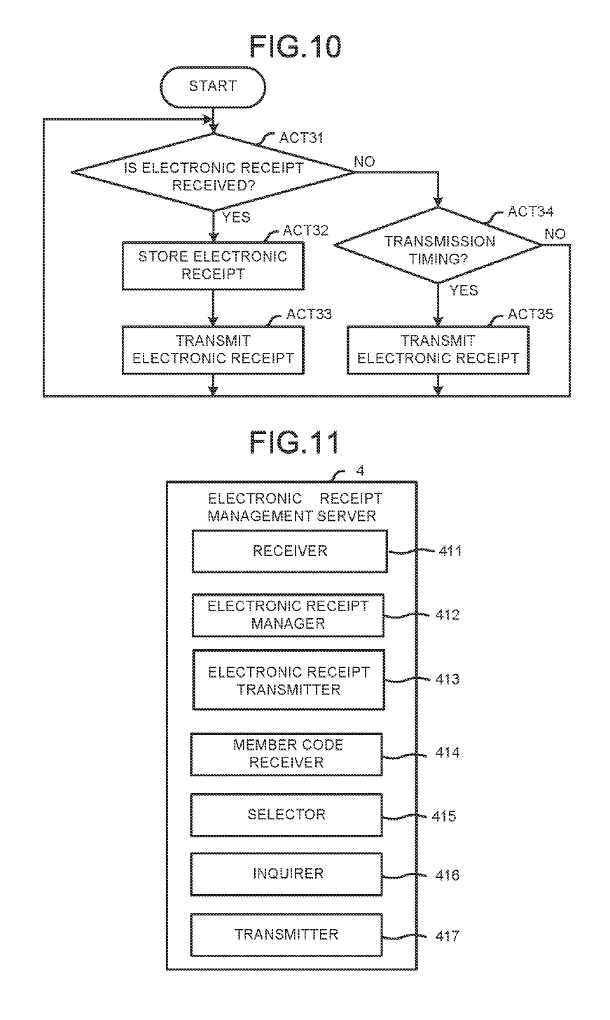

Next, an electronic receipt management processing performed when the controller 31 of the electronic receipt server 3 executes the electronic receipt management program 33b and an information transmission processing performed when the controller 31 of the electronic receipt server 3 executes the information transmission program 33c are described with reference to a flowchart shown in FIG. 10.

If the electronic receipt transmitted from the POS terminal 1 is received through the communication I/F 32 (YES in ACT 31), the controller 31 of the electronic receipt server 3 stores the received electronic receipt in the electronic receipt management region 33a of the storage unit 33 (ACT 32). Then, the controller 31 of the electronic receipt server 3 transmits the electronic receipt stored in ACT 32 to the electronic receipt management server 4 (ACT 33), and then the process returns to ACT 31.

Further, the controller 31 of the electronic receipt server 3 transmits the electronic receipt that is stored in the electronic receipt management region 33a to the electronic receipt management server 4 (ACT 35) when a predetermined transmission time has passed (NO in ACT 31→YES in ACT 34), and then the process returns to ACT 31. Through the process of ACT 35, electronic receipts that have not been successfully transmitted in ACT 33 can be transmitted to the electronic receipt management server 4. Further, it may be controlled such that only the electronic receipts that have not been successfully transmitted in ACT 33 are transmitted in ACT 35.

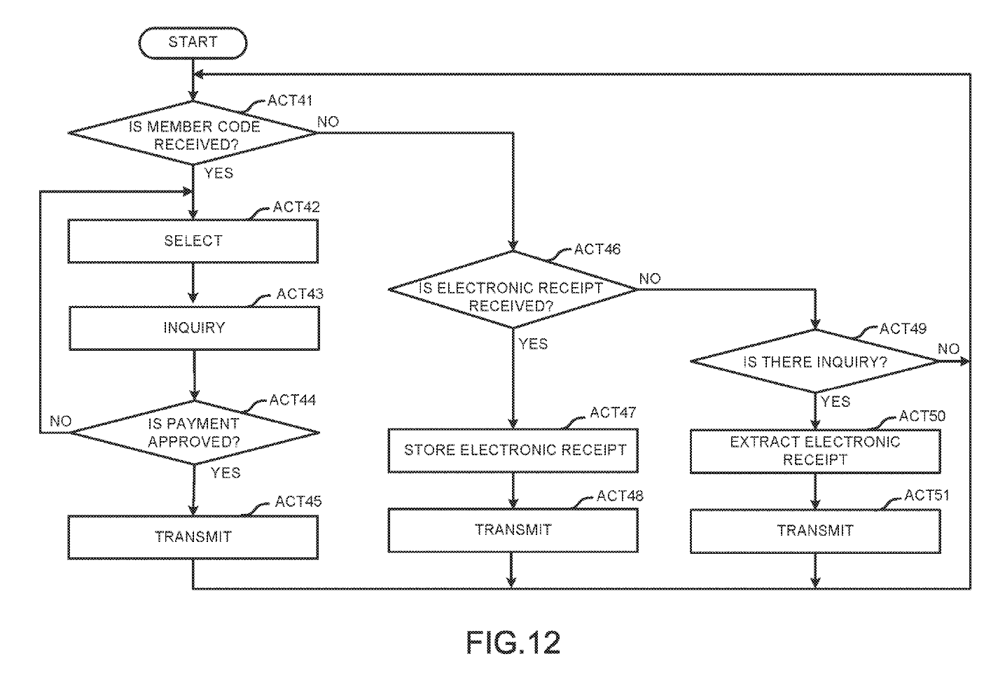

Next, electronic receipt management processing performed when the controller 41 of the electronic receipt management server 4 executes the electronic receipt management program 43c and commodity information transmission processing performed when the controller 41 of the electronic receipt management server 4 executes the information transmission program 43d are described with reference to a functional block diagram shown in FIG. 11 and a flowchart shown in FIG. 12.

As shown in FIG. 11, when the electronic receipt management program 43c and the information transmission program 43d are executed by the electronic receipt management server 4, modules including a receiver 411, an electronic receipt manager 412 functioning as storage, an electronic receipt transmitter 413, a member code receiver 414, a selector 415, an inquirer 416, and a transmitter 417 are generated. As practical hardware, by reading the electronic receipt management program 43c and the information transmission program. 43d from the storage unit 43 and then executing the programs using the CPU of the controller 41, the aforementioned sections are loaded in the RAM. As a result, the receiver 411, the electronic receipt manager 412, the electronic receipt transmitter 413, the member code receiver 414, the selector 415, the inquirer 416 and the transmitter 417 are generated in the RAM.

The member code receiver 414 receives the member code of a purchaser (consumer) during a purchase transaction of commodities subjected to the commodity sales data processing.

The selector 415 selects a payment medium (for example, a credit card, an electronic money card, a debit card, and the like) that is associated with the member code received by the member code receiver 414. More specifically, the selector 415 selects a payment medium of the highest priority (for example, credit card) from many payment media that are associated with the member codes received by the member code receiver 414, with reference to the member master stored in the member master management region 43b. In addition, the selector 415 selects, with reference to the member master stored in the member master management region 43b, a medium category of the highest priority (for example, the credit company A) from one or more medium categories (for example, a credit company A, a credit company B, a credit company C, . . . ) that is associated with the payment medium of the highest priority (for example, credit card).

The inquirer 416 requests for approval of the payment to a payment server 5 located in a payment center P4 corresponding to a selected payment medium.

When the payment has been approved as the result of the request to the payment server 5 in the payment center P4, the transmitter 417 transmits the message indicating that the payment has been approved to the transmission destination associated with the member code received by the member code receiver 414.

The receiver 411 receives the electronic receipt (electronic receipt information) of the structured format relating to the receipt data indicating the content of an approved purchase transaction from the electronic receipt server 3. The electronic receipt includes a company code and is electronically processed and issued, instead of a printed receipt, during the commodity sales data processing.

The receiver 411 further receives the electronic receipt of the structured format relating to the payment slip data as the proof of the payment processing by the payment medium selected by the selector 415, from the electronic receipt server 3.

The electronic receipt manager 412 stores and manages the electronic receipt of a company unit received by the receiver 411 in the electronic receipt management region 43a of the storage unit 43.

The electronic receipt transmitter 413 acquires an electronic receipt including at least one company code associated with the member code from the electronic receipt management region 43a, and transmits (outputs) the electronic receipt to the portable terminal 7 associated with the member code.

Here, the electronic receipt transmitter 413 may transmit (output) the receipt data and the payment slip data relating to the same transaction as a single electronic receipt (data file). Further, the electronic receipt transmitter 413 may separately transmit (output) the receipt data and the payment slip data relating to the same transaction as different electronic receipt information (i.e., two different data files).

As shown in FIG. 12, the member code receiver 414 of the electronic receipt management server 4 determines whether or not the member code of the purchaser (consumer) is received through the communication I/F 42 during the payment processing (ACT 41).

When the member code of the purchaser (consumer) is received during the payment processing (YES in ACT 41), the selector 415 of the electronic receipt management server 4 selects a payment medium with reference to the member master stored in the member master management region 43b (ACT 42). For example, a credit card issued by the credit company A is selected as the payment medium in ACT 42.

Next, the inquirer 416 of the electronic receipt management server 4 requests for the approval of the payment to the payment server 5 in the payment center P4 corresponding to the selected payment medium (ACT 43).

When the payment has been approved as a result of the request sent to the payment server 5 in the payment center P4 (YES in ACT 44), the transmitter 417 of the electronic receipt management server 4 transmits a message indicating that the payment has been approved to the transmission destination associated with the member code received by the member code receiver 414 (ACT 45).

On the other hand, when the payment is not approved (NO in ACT 44), the process returns to ACT 42, and the selector 415 of the electronic receipt management server 4 selects an another payment medium with reference to the member master stored in the member master management region 43b. Here, if there is another medium category, a medium category of which the priority order is ranked next (for example, the credit company B) is selected. If there is no another medium category, a payment medium of which the priority order is ranked next (for example, the debit card) is selected.

On the other hand, as shown in FIG. 12, when the member code is not received in ACT 41, the receiver 411 of the electronic receipt management server 4 determines whether or not the electronic receipt transmitted from the electronic receipt server 3 of each company is received through the communication I/F 42 (ACT 46).

When the electronic receipt is received (YES in ACT 46), the electronic receipt manager 412 of the electronic receipt management server 4 stores the electronic receipt in the electronic receipt management region 43a of the storage unit 43 (ACT 47).

Next, the electronic receipt transmitter 413 transmits the electronic receipt stored in ACT 47 to the transmission destination (portable terminal 7) managed in association with the member code of the electronic receipt (ACT 48), and then the process returns to ACT 41.

Further, when there is an electronic receipt inquiry from the portable terminal 7 (YES in ACT 49), the electronic receipt transmitter 413 of the electronic receipt management server 4 extracts the electronic receipt stored in the electronic receipt management region 43a according to the content of the electronic receipt inquiry (ACT 50).

Next, the electronic receipt transmitter 413 transmits the extracted electronic receipt to the transmission destination (portable terminal 7) managed in association with the member code of the electronic receipt (ACT 51), and then the process returns to ACT 41.

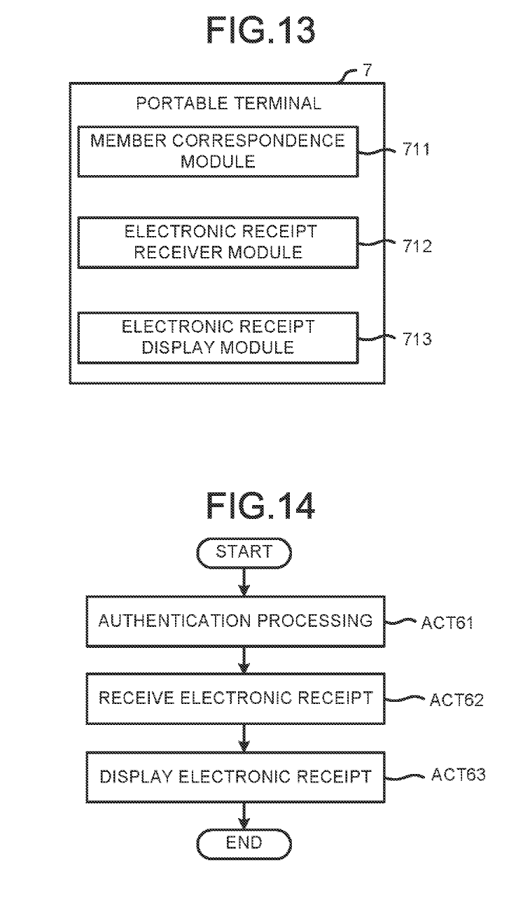

Next, electronic receipt receiving processing performed wen the controller 71 of the portable terminal 7 executes the electronic receipt correspondence program 75a and electronic receipt displaying processing performed when the controller 71 of the portable terminal 7 executes the electronic receipt browsing program 75b are described with reference to FIG. 13-FIG. 16.

As shown in FIG. 13, when the electronic receipt correspondence program 75a and the electronic receipt browsing program 75b are executed by the portable terminal 7, modules including a member correspondence module 711, an electronic receipt receiver module 712, and an electronic receipt display module 713 are generated. As practical hardware, by reading the electronic receipt correspondence program 75a and the electronic receipt browsing program 75b from the storage unit 75 and then executing these programs using the CPU of the controller 71, the member correspondence module 711, the electronic receipt receiver module 712, and the electronic receipt display module 713 are generated in the RAM.

The member correspondence module 711 associates a member code of a purchaser (user) therewith. The electronic receipt receiver module 712 receives the electronic receipt from the electronic receipt management server 4. The electronic receipt display module 713 operates to display the electronic receipt received by the electronic receipt receiver module 712 on the display unit 73.

As shown in FIG. 14, first, the member correspondence module 711 of the portable terminal 7 accesses the electronic receipt management server 4 and executes authentication processing based on a member code and a password input by the user (ACT 61). As a result, the portable terminal 7 and the member code of the specific purchaser are correlated.

After the authentication is carried out, the electronic receipt receiver module 712 of the portable terminal 7 receives an electronic receipt corresponding to the input member code, which is stored in the electronic receipt management region 43a of the electronic receipt management server 4 (ACT 62). Here, the receipt data may be received through an electronic mail.

Next, the electronic receipt display module 713 of the portable terminal 7 displays the electronic receipt and the like received by the electronic receipt receiver module 712 on the display unit 73 (ACT 63), and then terminates the processing.

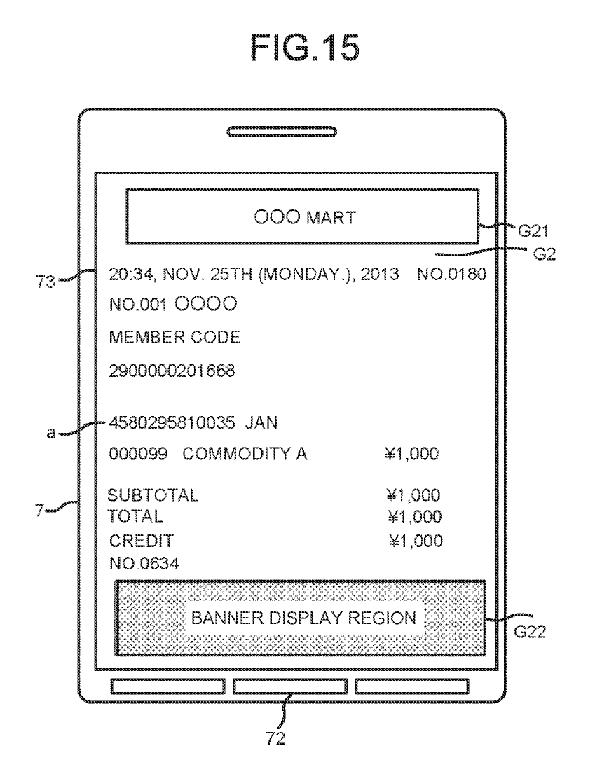

FIG. 15 illustrates an example of an electronic receipt G2. As shown in FIG. 15, the electronic receipt G2 is displayed with the same layout and content as the paper receipt.

On the display unit 73, a purchased commodity can be selected using a cursor that follows user inputs on the input device 72. Further, the electronic receipt G2 includes a store name logo region G21, a banner display region G22 displaying an advertisement, and the like.

The electronic receipt can be a substitute of a paper receipt, and a proof of a purchase transaction. Thus, as shown in FIG. 15, the electronic receipt used as the proof of a purchase transaction may include the following information.
store name
purchase date and time
details of purchased commodity
total price
register number
transaction number

Further, when a plurality of electronic receipts is received, the display unit 73 may display a selection screen to select one of the electronic receipts based on the purchase date and time, the company code, and the like contained in the electronic receipts. In this case, the electronic receipt display module 713 displays an electronic receipt selected through the selection screen on the display unit 73.

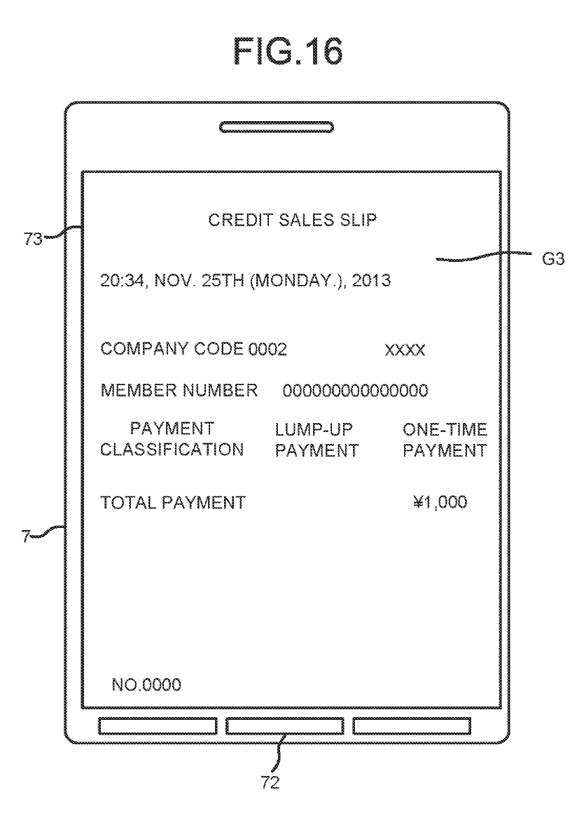

FIG. 16 illustrates an example of a payment slip G3. As shown in FIG. 16, the payment slip G3 is displayed with the same layout and content as a paper payment slip.

The payment slip G3 may be continuously displayed with the electronic receipt G2 of the same transaction, or may also be displayed separately from the electronic receipt G2.

As described above, according to the electronic receipt management server 4 of the present embodiment, when a payment medium (for example, a credit card, an electronic money card, a debit card, and the like) that is associated with the member code (reception destination code) of the consumer at the time of the purchase transaction (commodity transaction data processing) is selected and a payment has been approved as a result of a request to a payment server corresponding to the selected payment medium, a message indicating that the payment has been approved is transmitted to the transmission destination of the member code. Further, an electronic receipt of the structured-format for the approved purchase transaction is output to the information processing apparatus associated with the member code.

Moreover, according to the electronic receipt management server 4 of the present embodiment, the consumer may not need to present the payment medium during the purchase transaction. As no data of the payment medium does not need to be transmitted from the POS terminal to the electronic receipt server and further to the electronic receipt management server, more secure purchase transaction can be conducted. Also, as there is less risk that information of the payment medium is stolen by others during the purchase transaction, more secure purchase transaction can be conducted.

In the present embodiment, when the closing processing is instructed (YES in ACT 16) and the member code is acquired in ACT 12 (YES in ACT 17), the member code acquired in ACT 12 is transmitted to the electronic receipt management server 4 to inquire an identification code and a designated (prioritized) payment medium (for example, a credit card, an electronic money card, a debit card and the like) that is associated with the member code (ACT 18). However, the present invention is not limited to this process. For example, in ACT 18, a company code (identification code of a company operating the store: transaction destination code) may be transmitted to the electronic receipt management server 4 together with the member code acquired from the POS terminal 1 in ACT 12.

In this case, the payment medium (for example, a credit card, an electronic money card, a debit card, and the like) and the medium category (for example, a credit company A, a credit company B, a credit company C, may be stored in association with the company code (transaction destination code) in the storage unit 43 of the electronic receipt management server 4. Then, the member code receiver 414 of electronic receipt management server 4 may receive the member code of the purchaser (consumer) and the company code (transaction destination code). The selector 415 of the electronic receipt management server 4 may determine whether or not the payment medium and the medium category associated with the company code (transaction destination code) are stored, and, if there are the associated payment medium and medium category, selects the payment medium and the medium category for the payment processing.

For example, when a company operating a convenience store has issued a credit card, it is possible to preferentially select the credit card for the payment of the purchase transaction in the convenience store.

### Second Embodiment

Next, a second embodiment is described with reference to the drawings. Further, the same reference numerals are applied to the same components as the first embodiment described above, and the detailed description thereof may be omitted.

In the first embodiment, the payment medium is associated with the customer code, and the associated payment medium is used for a purchase transaction. Further, the electronic receipt indicating the content of the purchase transaction and the payment slip data serving as the proof of the payment by the payment medium are generated as data of a structured format.

In the second embodiment, an identification code of a payment medium used in payment processing is associated with the customer code, the payment processing by the payment medium is carried out through the customer presenting the payment medium, and the customer code, which is used to generate the electronic receipt, is obtained based on the identification code. The electronic receipt is obtained by converting a receipt data containing the content of the purchase transaction and a payment slip data serving as the proof of the payment processing using the medium, into a structured format.

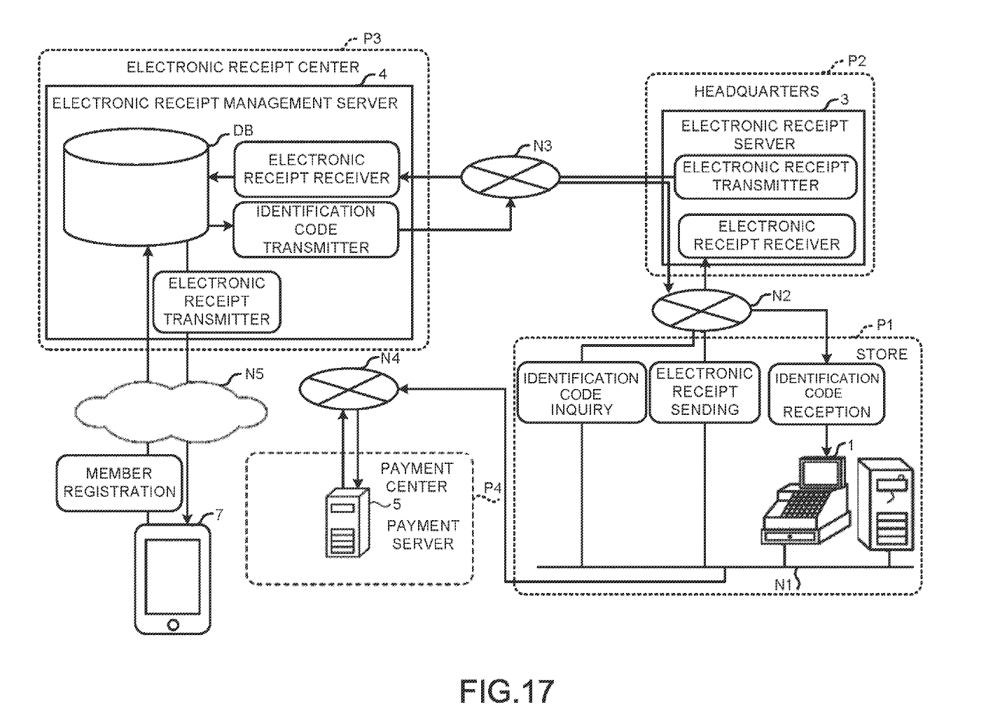

FIG. 17 is a block diagram of an electronic receipt system according to the second embodiment. As shown in FIG. 17, the electronic receipt system includes the POS (Point Of Sales) terminal 1, the store server 2, the electronic receipt server 3, the electronic receipt management server 4, and the portable terminal 7.

The POS terminal 1 is connected to the payment server 5 located in the payment center P4 serving as a financial institution, such as a credit company, a bank, an electronic money bank, and the like, via the network N4. Here, the network N4 is, for example, a dedicated line such as the CAFIS (Credit and Finance Information Switching System), the VPN and the like. With respect to this point, in the first embodiment, the electronic receipt management server 4, not the POS terminal 1, is connected to the payment server 5 in the payment center P4 via the network N4, which is different from the second embodiment.

The electronic receipt management server 4 functions as a receipt management server for customer and collectively manages the receipt data of multiple companies operating stores. The electronic receipt management server 4 stores the member data such as name, a member code of each customer (member) who carried out the member registration, transmission destination information of the electronic receipt (for example, a mail address) associated with the portable terminal 7, an identification code of a payment medium (for example, a credit card, an electronic money card, a debit card, and the like) used in the payment processing in the POS terminal 1, and the like, in the member master in the database DB. A member management server carrying out the storage/management of member data and the like may be arranged separately from the electronic receipt management server 4.

The member registration of a customer in the electronic receipt system according to the present embodiment may be carried out through the following procedure. The customer transmits a blank mail from the portable terminal 7 to the electronic receipt management server 4 through the network N5. The electronic receipt management server 4 transmits a URL (Uniform Resource Locator) of a webpage for member registration to the received mail address. The customer accesses the webpage for member registration through the portable terminal 7, and the portable terminal 7 displays an input screen for inputting information (name, transmission destination information, and the like) required for the member registration. After the required information of the customer is input, the electronic receipt management server 4 executes the member registration in the member master. Here, as the information to be input by the customer, an identification code of a payment medium (for example, a credit card, an electronic money card, a debit card, and the like) to be used in the payment processing is also contained. Then, the electronic receipt management server 4 distributes a member registration completion mail including a member code (customer code) and a password to the portable terminal 7. As a result, the member registration is completed.

In the present embodiment, the member master stored in the member master management region 43b of the electronic receipt management server 4 stores the identification code of the payment medium to be used in the payment processing in association with the member code. The payment medium is, for example, a credit card, an electronic money card, a debit card, and the like. In the present embodiment, the credit card is used as the payment medium.

Next, the operations of each unit of the electronic receipt system according to the present embodiment are described.

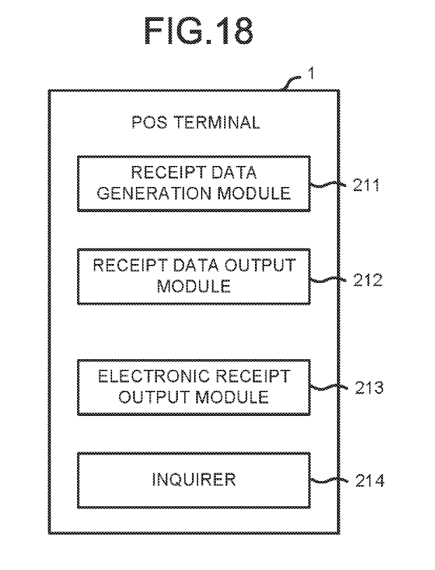

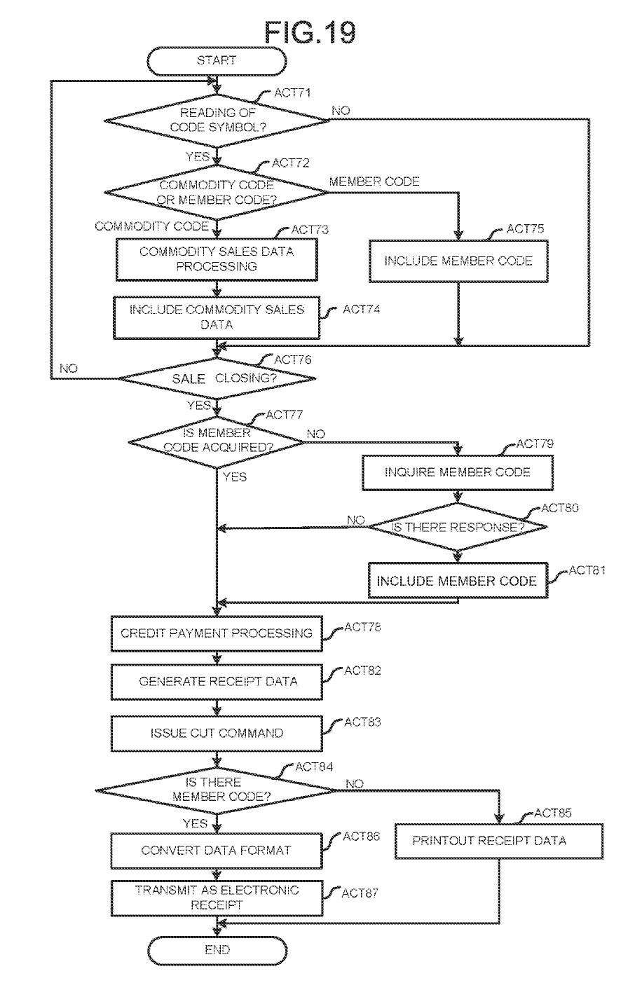

First, electronic receipt processing executed when the controller 11 of the POS terminal 1 executes the receipt data processing program 17a is described with reference to FIG. 18-FIG. 19.

As shown in FIG. 18, when the receipt data processing program 17a is executed by the POS terminal 1, modules including a receipt data generation module 211, a receipt data output module 212, an electronic receipt output module 213, and an inquirer 214 are generated. As practical hardware, the CPU of the controller 11 reads the receipt data processing program 17a from the storage unit 17 and then executes the program. As result, the receipt data generation module 211, the receipt data output module 212, the electronic receipt output module 213, and the inquirer 214 are generated in the RAM.

At the time of payment by a credit card, which is a payment medium to be used for a purchase transaction, the inquirer 214 transmits an identification code of the credit card to the electronic receipt management server 4 via the network N2, the electronic receipt server 3, and the network N3. In addition, the inquirer 214 inquires a member code (reception destination code) of a customer (reception destination) associated with the identification code of the credit card.

The receipt data generation module 211 is a functional unit which mainly carries out the commodity sales data processing, generates printing data of a receipt (receipt data), and corresponds to an existing application. When the commodity code of a commodity is acquired through the code scanner 15, the receipt data generation module 211 reads the commodity data corresponding to the commodity code from the commodity data file and calculates the price of the commodity based on a unit price contained in the commodity data. Then, the receipt data generation module 211 generates the commodity sales data through the commodity sales data processing, that is, the receipt data including the content of the purchase transaction.

If the member code (reception destination code) of the customer (reception destination) is acquired through the code scanner 15 at any timing during one purchase transaction, the receipt data generation module 211 includes the member code in the receipt data (refer to FIG. 7). Further, the reception destination code is not limited to the member code, and may be an identification code of the reception destination.

When there is a response of the member code (reception destination code) associated with the identification code of the credit card from the electronic receipt management server 4, via the network N3, the electronic receipt server 3, and the network N2, the receipt data generation module 211 further includes the member code in the receipt data (refer to FIG. 7).

If the press of the closing key is detected, the receipt data generation module 211 determines that the commodity sales data processing of the purchase transaction has been completed, and outputs (issues) the generated receipt data and a cut command to the receipt data output module 212. Here, the cut command is one of a printer control commands generally used, and instructs the cut (cutting) of paper on which the receipt data is printed. Further, the receipt data may be generated collectively after the press of the closing key, or may be generated sequentially every time a commodity code or a customer code is acquired.

When the receipt data of one purchase transaction is generated by the receipt data generation module 211, the receipt data output module 212 determines an output destination of the generated receipt data. More specifically, if the cut command is issued by the receipt data generation module 211, the receipt data output module 212 determines that the receipt data of the one purchase transaction is generated. Then, the receipt data output module 212 determines whether or not the generated receipt data contains the member code, and outputs the receipt data to a specific output destination according to the determination result.

Specifically, if it is determined that the receipt data does not contain the member code, the receipt data output module 212 outputs the receipt data to the printer 13 together with the cut command. Then, the printer 13 prints the receipt data on the paper, and outputs a paper receipt of the purchase transaction after cutting the paper according to the cut command. Here, during the printing, all elements of the receipt data may be printed, or the receipt data may be printed after removing the member code and the like or adding other information such as an advertisement.

If it is determined that the receipt data contains the member code, the electronic receipt output module 213 converts the receipt data into a predetermined data format according to a conversion rule defined in the receipt data schema 17c. Then, the receipt data output module 212 transmits (outputs) the receipt data of which the data format has been converted, that is, the electronic receipt (refer to FIG. 8), to the electronic receipt server 3 of the company.

In this way, the receipt data output module 212 determines, according the cut command by the receipt data generation module 211, that the receipt data of one purchase transaction is generated and starts the output of the receipt data. As no dedicated signal to notify the receipt data output module 212 of the completion of one purchase transaction is necessary to be sent from the receipt data generation module 211, the output of the receipt data of one purchase transaction can be carried out by the receipt data output module 212 without modifying the receipt data generation module 211, which corresponds to the existing application. Since the receipt data generation module 211 does not need modification, it is possible to provide the electronic receipt while efficiently using the existing application.

Further, in the present embodiment, the receipt data output module 212 determines, according to whether or not a receipt data contains the member code, an output destination of the receipt data. Thus, the determination of the output form of the receipt data can be carried out without using dedicated information designating the output form, it is possible to determine the output destination of the receipt data efficiently. For example, the customer (member) can select the output of paper receipt or electronic receipt through input/non-input of the member code during each purchase transaction, which can improve the convenience of the customer.

When the receipt data is output to the electronic receipt server 3, the electronic receipt output module 213 further converts the elements contained in the receipt data into the structured electronic receipt and then outputs the electronic receipt. Consequently, the elements contained in the electronic receipt can be used more efficiently by the electronic receipt server 3 and the electronic receipt management server 4 in managing the electronic receipt and by the portable terminal 7 in displaying the electronic receipt.

FIG. 19 is a flowchart illustrating electronic receipt processing carried out by the POS terminal 1. First, the receipt data generation module 211 of the POS terminal 1 determines whether or not a code symbol (commodity code) printed on a commodity or a code symbol (member code) displayed on the portable terminal 7 is read through the code scanner 15 (ACT 71). When the code symbol is not read (NO in ACT 71), the process moves to ACT 76.

To the contrary, if it is determined that the code symbol is read (YES in ACT 71), the receipt data generation module 211 determines whether or not the read code symbol is a commodity code or a member code (ACT 72).

In ACT 72, when the read code symbol is the commodity code (ACT 72: commodity code), the receipt data generation module 211 reads the commodity data of the commodity specified by the commodity code from the commodity data file, and calculates a price of the commodity based on the unit price contained in the commodity data (ACT 73). Next, the receipt data generation module 211 generates the receipt data including the commodity sales data processed through the commodity sales data processing (ACT 74).

Further, when the read code symbol is the member code (ACT 72: member code), the receipt data generation module 211 generates the receipt data including the member code (ACT 75).

In order to input the member code to the POS terminal 1, the customer (member) may present the code symbol representing the member code and the like displayed on the display unit 73 of the portable terminal 7, and the shop clerk or the customer (member) scans the code symbol using the code scanner 15 of the POS terminal 1. Further, the receipt data generation module 211 may perform exclusive processing such that only one member code is associated with the purchase transaction when two or more member codes are input during the purchase transaction.

Sequentially, in ACT 76, the receipt data generation module 211 determines whether or not the closing processing by the credit card is instructed according to the press of a credit key (ACT 76). When the closing processing by the credit card is not instructed (NO in ACT 76), the process returns to ACT 71. When the closing processing by the credit card is instructed (YES in ACT 76) and the member code is acquired in ACT 72 (YES in ACT 77), the closing processing (credit payment processing) by the credit card is executed (ACT 78).

On the other hand, when the member code is not acquired in ACT 72 (NO in ACT 77), the receipt data generation module 211 transmits the identification code of the credit card to the electronic receipt management server 4 via the network N2, the electronic receipt server 3, and the network N3 and inquires a member code associated with the identification code of the credit card (ACT 79).

When there is a response of the member code associated with the identification code of the credit card from the electronic receipt management server 4, via the network N2, the electronic receipt server 3, and the network N3 (YES in ACT 80), the receipt data generation module 211 includes the member code in the receipt data (ACT 81), and the process proceeds to ACT 78.

When there is no response from the electronic receipt management server 4 (NO in ACT 80), the process proceeds to ACT 78 directly.

After the closing processing (credit payment processing) is executed, the receipt data generation module 211 generates receipt data of one purchase transaction containing the content thereof by the credit payment (ACT 82). Further, when the closing processing (credit payment processing) is executed, the receipt data generation module 211 also generates payment slip data (customer-oriented) of a preset format as the proof of the credit payment processing.

Next, the receipt data generation module 211 issues (outputs) a cut command to a receipt data output module 212 (ACT 83).

If the cut command is received from the receipt data generation module 211, the receipt data output module 212 determines that the receipt data of the purchase transaction is generated, and determines whether or not the receipt data contains the member code (ACT 84).

When the receipt data does not contain the member code (NO in ACT 84), the receipt data output module 212 outputs the receipt data of the purchase transaction to the printer 13 together with the cut command so that the receipt data is printed out (ACT 85), and terminates the processing. Then, the printer 13 prints the receipt data on the paper, and outputs a paper receipt after cutting the paper according to the cut command.

Further, the printer 13 also prints out payment slip data (customer-oriented) of the predetermined format as the proof of the credit payment.

On the other hand, when the receipt data contains the member code (YES in ACT 84), the receipt data output module 212 converts the data format of the receipt data (unstructured format) into a structured format, as an electronic receipt (ACT 86).

Further, the electronic receipt output module 213 converts the data format of the payment slip data (customer-oriented) into the structured format and include it in the electronic receipt.

Then, the electronic receipt output module 213 transmits the generated electronic receipt to the electronic receipt server 3 via the communication I/F 16 (ACT 87), and terminates the processing.

In the processing described above, when the receipt data contains the member code, the receipt data is output to the electronic receipt server 3. However, the present invention is not limited to this processing. For example, the receipt data may be output to both the printer 13 and the electronic receipt server 3.

Further, when the receipt data contains the member code, the output destination of the receipt data may be set to be selectable. For example, the portable terminal 7 may contain output classification information designating the output destination of the receipt data in the code symbol to be displayed and select the output destination based on the output classification information. In this case, the receipt data generation module 211 includes the output classification information read by the code scanner 15 in the receipt data together with the member code. Then, if it is determined that the receipt data contains the member code and the output classification information, the receipt data output module 212 determines the output destination of the receipt data based on the output classification information. Here, the output classification information may designate either one or both of the printer 13 and the electronic receipt server 3 as the output destinations.

Further, the output destination of the receipt data may be selected every time the purchase transaction is carried out. In such a case, for example, if it is determined that the receipt data contains the member code, the receipt data output module 212 displays an output destination selection screen for selecting the output destination of the receipt data on the display unit 14.

Further, the selection screen may be displayed on either one or both of the display 14a for operator and the display 14b for customer. In addition, when the display 14b for customer has a touch panel, the customer may select the output destination by herself/himself using the touch panel.

Further, the output destination of the receipt data may be selected by the customer during the commodity sales data processing. At this time, the receipt data generation module 211 displays an output destination selection screen and the like on the display unit 14, and the output destination corresponding to the customer's operation may be contained in the receipt data as the output classification information. Then, if the receipt data contains the member code and the output classification information, the receipt data output module 212 determines the output destination of the receipt data based on the output classification information.

As described above, when the receipt data contains the member code, the receipt data output module 212 receives the automatic selection of the output destination of the receipt data or the manual selection of the output destination. Thus, the determining method of the output destination can be flexibly switched.

The operations of the electronic receipt server 3 are the same as those in the first embodiment described above, and thus the detailed description thereof is not provided.

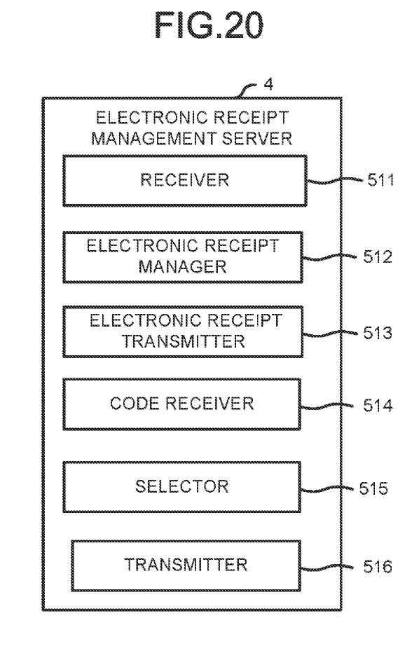

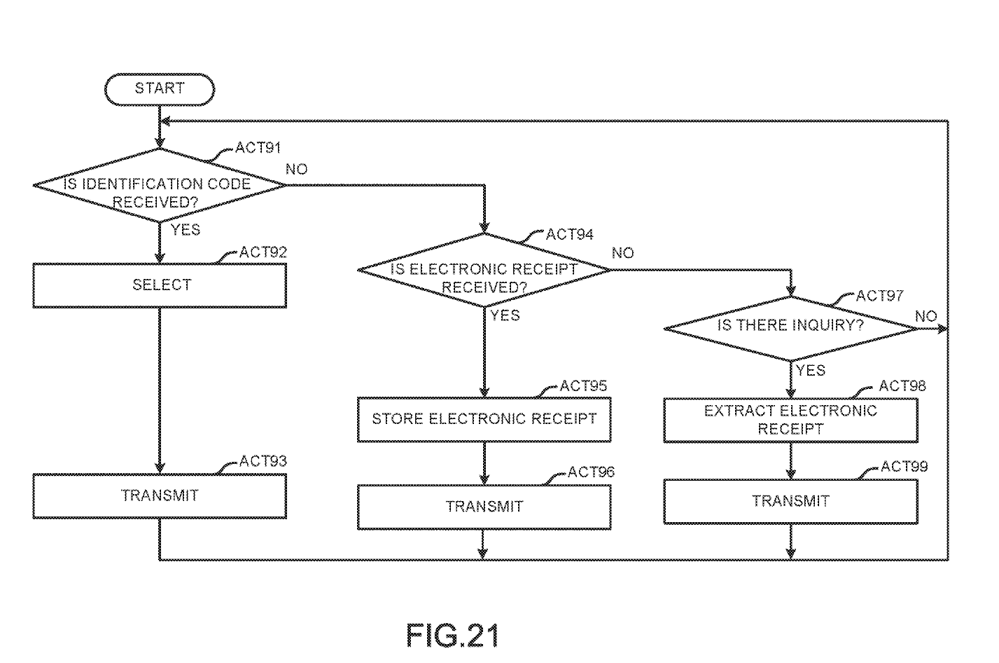

Next, electronic receipt management processing executed when the controller 41 of the electronic receipt management server 4 executes the electronic receipt management program 43c and commodity information transmission processing executed when the controller 41 of the electronic receipt management server 4 executes the information transmission program 43d are described with reference to the functional block diagram shown in FIG. 20 and the flowchart shown in FIG. 21.

As shown in FIG. 20, when the electronic receipt management program 43c and the information transmission program 43d executed by the electronic receipt management server 4, modules including a receiver 511, an electronic receipt manager 512 functioning as storage, an electronic receipt transmitter 513, a code receiver 514, a selector 515, and a transmitter 516 are generated. As practical hardware, the CPU of the controller 41 reads the electronic receipt management program 43c and the information transmission program 43d from the storage unit 43 and executes these programs, and the aforementioned modules are loaded in the RAM. As a result, the receiver 511, the electronic receipt manager 512, the electronic receipt transmitter 513, the code receiver 514, the selector 515, and the transmitter 516 are generated in the RAM.

The code receiver 514 receives an identification code of the payment medium, when the payment is carried out with a payment medium (for example, a credit card, an electronic money card, a debit card, and the like) for the commodity transaction data processing.

The selector 515 selects a member code (reception destination code) of a customer (reception destination) associated with the identification code received by the code receiver 514. More specifically, the selector 515 selects, with reference to the member master stored in the member master management region 43b, a member code (reception destination code) associated with the identification code received by the code receiver 514.

The transmitter 516 transmits the selected member code (reception destination code) to a transmission destination associated with the identification code of the payment medium received by the code receiver 514.

The receiver 511 receives the electronic receipt (electronic receipt information) of the structured format, which corresponds to the receipt data containing the content of the purchase transaction and with which the member code (reception destination code) is associated, from the electronic receipt server 3. The electronic receipt includes a company code of the company operating the store and electronically processed and issued instead of the paper receipt during the commodity sales data processing.

The receiver 511 further receives the payment slip data of the structured format as the proof of the payment processing by the payment medium selected by the selector 515, from the electronic receipt server 3.

The electronic receipt manager 512 stores and manages the electronic receipt received by the receiver 511 in the electronic receipt management region 43a of the storage unit 43.

The electronic receipt transmitter 513 acquires an electronic receipt including at least one company code and associated with the member code from the electronic receipt management region 43a and transmits (outputs) the electronic receipt to the portable terminal 7 associated with the member code (reception destination code) of the customer.

Further, the electronic receipt transmitter 513 may transmit (output) the receipt data and the payment slip data of the same transaction as a single electronic receipt (data file). Alternatively, the electronic receipt transmitter 513 may also separately transmit (output) the receipt data and the payment slip data relating to the same transaction as different electronic receipt information (two different data files).

As shown in FIG. 21, the code receiver 514 of the electronic receipt management server 4 determines whether or not an identification code of the payment medium is received through the communication I/F 42 during the payment processing by a payment medium (for example, a credit card) selected through the commodity sales data processing (ACT 91).

When the identification code of the payment medium is received during the payment processing by the payment medium (for example, the credit card) (YES in ACT 91), the selector 515 of the electronic receipt management server 4 selects a member code (transmission destination code) associated with the received identification code with reference to the member master stored in the member master management region 43b (ACT 92).

Next, the transmitter 516 of the electronic receipt management server 4 transmits the selected member code (reception destination code) to a transmission destination associated with the identification code of the payment medium received by the code receiver 514 (ACT 93).

On the other hand, as shown in FIG. 21, the receiver 511 of the electronic receipt management server 4 determines whether or not the electronic receipt transmitted from the electronic receipt server 3 of each company is received through the communication I/F 42 (ACT 94).

When the electronic receipt is received (YES in ACT 94), the electronic receipt manager 512 of the electronic receipt management server 4 stores the electronic receipt of each company in the electronic receipt management region 43a of the storage unit 43 (ACT 95).

Sequentially, the electronic receipt transmitter 513 transmits the electronic receipt stored in ACT 95 to a transmission destination (portable terminal 7) that is managed in association with the member code of the electronic receipt (ACT 96), and then the process returns to ACT 91.

Further, when there is an electronic receipt inquiry from the portable terminal 7 (YES in ACT 97), the electronic receipt transmitter 513 of the electronic receipt management server 4 extracts the electronic receipt that is stored in the electronic receipt management region 43a, according to the electronic receipt inquiry (ACT 98).

Next, the electronic receipt transmitter 513 transmits the extracted electronic receipt to the transmission destination (portable terminal 7) that is managed in association with the member code of the electronic receipt (ACT 99), and then the process returns to ACT 91.

The operations of the portable terminal 7 are the same as those in the first embodiment described above, and thus the detailed description thereof is not provided.

According to the present embodiment, during the payment processing by a payment medium (for example, a credit card, an electronic money card, a debit card and the like) selected through the commodity transaction data processing in the POS terminal, an identification code of the payment medium is input to the electronic receipt management server 4. The electronic receipt management server 4 determines a member code (reception destination code) of a customer (reception destination) associated with the identification code of the payment medium and transmits the determined member code (reception destination code) to a transmission destination associated with the identification code. Further, the electronic receipt management server 4 receives the electronic receipt of the structured format that contains the content of a purchase transaction by the payment medium and with which the member code (reception destination code) is associated and outputs the electronic receipt to an information processing apparatus associated with the member code. When a credit payment is carried out and an electronic receipt is issued, the customer only needs to presents the credit card (payment medium), and thus it is possible to perform the sales data processing more efficiently.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

Although, in the embodiments described above, the member code and the like are acquired through the code scanner 15, the present invention is not limited to this configuration. For example, A unit that performs a near-distance wireless communication, such as a NFC (Near Field Communication), a Bluetooth (registered trademark), and the like, may be disposed in the portable terminal 1 and the portable terminal 7, and the member code and the like may be transmitted/received using the near-distance wireless communication. In this case, the portable terminal 7 stores the member code and the like in the storage unit 75 or an IC tag (not shown) and the like.

Further, in the embodiments described above, the member code and the like are acquired from the portable terminal 7; however, the present invention is not limited this configuration. For example, the member code may be acquired from a medium, such as an IC card, a magnetic card and the like, that can store the member code. In a case of using the IC card, the POS terminal 1 has a reading/writing unit such as an IC card reader/writer. Further, in a case of using the magnetic card, the POS terminal 1 has, for example, a card reader/writer of the magnetic card.

In the embodiments described above, the electronic receipt server 3 is located in the headquarters P2; however, the present invention is not limited to this configuration. For example, the electronic receipt server 3 for store may be located in the store P1. In this case, the POS terminal 1 outputs an electronic receipt to the electronic receipt server 3 connected to the in-store network N1, and the electronic receipt server 3 transmits the electronic receipt to the electronic receipt management server 4 through the in-store network N1 and the network N2.

Further, in the embodiments described above, the electronic receipt generated by the POS terminal 1 is output to the electronic receipt management server 4 via the electronic receipt server 3; however, the present invention is not limited to this configuration. For example, the electronic receipt may be output directly to the electronic receipt management server 4 by the electronic receipt management server 4 accessing the POS terminal 1 through the network N3.

Though, in the embodiments described above, the portable terminal 7 receives the electronic receipt via the electronic receipt management server 4, the present invention is not limited to this configuration. For example, the portable terminal 7 may receive the electronic receipt directly from the POS terminal 1. In this case, the POS terminal 1 outputs the generated electronic receipt to the portable terminal 7 connected through the in-store network N1 or using near-distance wireless communication. Further, in this case, the authentication processing may be carried out by the POS terminal 1.

Furthermore, in the embodiments described above, the commodity data file is stored in the POS terminal 1; however, the present invention is not limited to this configuration. For example, the commodity data file may be stored in the store server 2 in a referable manner from the POS terminal 1.

What is claimed is:

1. A distributed computer system configured to coordinate management of electronic records in a secure manner, comprising:
a central server configured to assign a user ID to a user when the user registers therewith, and store payment information of the user in association with the user ID;
a computing device of the user configured to generate a code symbol representing the user ID, and display the code symbol on a display unit thereof; and
a point-of-sale terminal configured to scan the code symbol displayed on the computing device and code symbols of merchandise being purchased, and generate first transaction information including the user ID represented by the code symbol and excluding the payment information and second transaction information including information about the purchased merchandise,
wherein a local server receives the first and second transaction information from the point-of-sale terminal and transmits the first transaction information to the central server and then the second transaction information to the central server upon receiving payment confirmation from the central server,
wherein, in response to receiving the first transaction information from the local server, the central server is configured to retrieve the payment information of the user that is stored in association with the user ID, and transmit the payment information to a payment processor to process payment for the merchandise being purchased, and
wherein, in response to receiving conformation that the payment has been approved, the central server transmits the payment confirmation to the local server.

2. The distributed computer system according to claim 1, wherein
the point-of-sale terminal is further configured to generate third transaction information indicating that the merchandise has been purchased through a payment method indicated by the payment information, and
the central server also receives the third transaction information through the local server.

3. The distributed computer system according to claim 2, wherein
the point-of-sale terminal is further configured to convert a format of the second and third transaction information into structured format.

4. The distributed computer system according to claim 2, wherein
the second and third transaction information are integrated into a single data file.

5. The distributed computer system according to claim 2, wherein
the second and third transaction information are separated into two different data files.

6. The distributed computer system according to claim 1, wherein
the payment information stored in the central server in association with the user ID includes payment information for a plurality of payment methods, and priority information of the payment methods, and
the central server is further configured to determine one of the payment methods based on the priority information.

7. The distributed computer system according to claim 1, wherein
the first transaction information includes a retailer ID of a retailer with which the point-of-sale terminal is associated,
the payment information stored in the central server includes payment information for a plurality of payment methods, one of which is associated with the retailer ID, and
the central server is further configured to select one of the payment methods based on the retailer ID included in the first transaction information.

8. The distributed computer system according to claim 1, wherein
the central server and the payment processor are connected to a network that is more secure than a network connected between the central server and the local server.

9. An operating method of a distributed computer system configured to coordinate management of electronic records in a secure manner between a central computing entity and local computing entities, said method comprising:
assigning a user ID to a user when the user registers with a central server that manages the electronic records in a secure manner;
storing, in the central server, payment information of the user in association with the user ID;
generating, at a computing device of the user, a code symbol representing the user ID, and displaying the code symbol on a display unit thereof;
scanning the code symbol displayed on the display unit of the computing device and code symbols of merchandise being purchased, at a point-of-sale terminal;
generating, at the point-of-sale terminal, first transaction information including the user ID represented by the code symbol and excluding the payment information and second transaction information including information about the purchased merchandise, wherein a local server receives the first and second transaction information from the point-of-sale terminal and transmits the first transaction information to the central server and then the second transaction information to the central server upon receiving payment confirmation from the central server; and
at the central server, in response to receiving the first transaction information from the local server, retrieving the payment information of the user that is stored in association with the user ID, transmitting the payment information to a payment processor to process payment for the purchased merchandise, and in response to receiving confirmation that the payment has been approved, transmitting the payment confirmation to the local server.

10. The method according to claim 9, further comprising:
generating, at the point-of-sale terminal, third transaction information indicating that the merchandise has been purchase through a payment method indicated by the payment information; and
receiving, at the central server, the third transaction information through the local server.

11. The method according to claim 10, further comprising:
converting, at the point-of-sale terminal, a format of the second and third transaction information into a structured format.

12. The method according to claim 10, wherein
the second and third transaction information are integrated into a single data file.

13. The method according to claim 10, wherein
the second and third transaction information are separated into two different data files.

14. The method according to claim 9, wherein the payment information stored in the central server in association with the user ID includes payment information for a plurality of payment methods, and priority information of the payment methods, the method further comprising:
selecting, at the central server, one of the payment methods based on the priority information.

15. The method according to claim 9, wherein the first transaction information includes a retailer ID of a retailer with which the point-of-sale terminal is associated, and the payment information stored in the central server includes payment information for a plurality of payment methods, one of which is associated with the retailer ID, the method further comprising:
selecting, at the central server, one of the payment methods based on the retailer ID included in the first transaction information.

16. The method according to claim 9,
the central server and the payment processor are connected to a network that is more secure than a network connected between the central server and the local server.

17. A distributed computer system configured to coordinate management of electronic records in a secure manner, comprising:
a central server configured to assign a user ID to a user when the user registers therewith, and store payment information of the user in association with the user ID; and
a point-of-sale terminal configured to obtain the payment information from a payment medium carried by the user, and generate first transaction information including the obtained payment information and second transaction information including information about the purchased merchandise,
wherein a local server receives the first and second transaction information from the point-of-sale terminal the point-of-sale terminal and transmits the first transaction information to the central server and a payment processor, and then the second transaction information to the central server upon receiving the user ID from the central server and payment approval from the payment processor, and
wherein, in response to receiving the first transaction information from the local server, the central server is configured to retrieve the user ID that is stored in association with the received payment information, and transmit the user ID to the local server.

18. The distributed computer system according to claim 17, wherein
the point-of-sale terminal is further configured to generate third transaction information indicating that the merchandise has been purchased through a method associated with the payment information, and
the central server receives the third transaction information through the local server.

19. The distributed computer system according to claim 18, wherein
the point-of-sale terminal is further configured to convert formats of the second and third transaction information into structured formats.

20. The distributed computer system according to claim 18, further comprising:
a computing device of the user configured receive the second and third transaction information from the central server, and display the second and third transaction information on a display unit thereof.
